(19) United States
(12) Patent Application Publication
(10) Pub. No.: US 2003/0081932 A1
(43) Pub. Date: May 1, 2003

(54) Computer-readable medium and method for providing a generic interface to a CD-recorder device

(76) Inventor: David H. Hanes, Loveland, CO (US)

Correspondence Address: HEWLETT-PACKARD COMPANY, Intellectual Property Administration, P.O. Box 272400, Fort Collins, FL, 80527-2400, US

(21) Appl. No.: 10/001,507

(22) Filed: Oct. 25, 2001

(51) Int. Cl. H04N 5/92; H04N 5/781

(52) U.S. Cl. 386/46; 386/125

(57) ABSTRACT

A computer-readable medium having stored thereon a set of instructions to be executed by a processor that cause the processor to perform a computer method of receiving, by an interface, a computer formatted file from an external computer application, converting, by a conversion module, the computer formatted file into a compact disc-compliant format, and outputting, by an output interface, the compact disc-compliant formatted data is provided. A method for converting a file into a compact disc-compliant format suitable for recording on a compact disc medium comprising receiving, by an interface to a compact disc recorder engine, a file in a first format that comprises data to be recorded on a compact disc from an external computer application, processing, by a module of the compact disc recorder engine, the file in the first format, and outputting, by the compact disc recorder engine, the data in a compact disc-compliant format is provided.

### TECHNICAL FIELD OF THE INVENTION

This invention relates to data storage and, more particularly, to a generic compact disc recorder interface tool.

### BACKGROUND OF THE INVENTION

The proliferation of the Internet has resulted in consumer demand for numerous bandwidth-intensive services. As market penetration of wideband consumer communications, such as digital subscriber line technologies, cable modem Internet access and other high-bandwidth data services, increase, the demand for data-intensive information and media will only increase. Downloading music and video has already become commonplace for a large population of Internet users.

Advances in data storage technologies are continually being made. Magnetic hard drives offer gigabytes of storage space at relatively low costs. However, many users consume massive amounts of storage space in short periods of time. A large number of consumers have turned to any number of commercially available removable data storage media because of the cost and/or labor required to upgrade a hard drive. Compact disc recorders (CD-Rs), or “burners,” are particularly attractive to consumers seeking low cost and high data storage capabilities. The introduction of re-writeable CD burners (CD-RW) to the marketplace has further increased the convenience of compact disc media. Furthermore, the interchange capabilities provided by compact disc media are not provided by most competing media products.

Although CD-Rs and CD-RWs are capable of writing CDs that are compatible with most commercially available CD players, a significant barrier remains to harnessing the capabilities of CD-Rs and CD-RWs. Presently, specialized software, commonly referred to as “mastering” or “pre-mastering” software, is required to format computer data and computer audio files, such as wave (.wav) files, MPEG-1 audio layer 3 (.mp3) files and other computer audio file formats, into a form suitable for storage on a CD. Mastering software generally requires the user to invoke the mastering software application, select the files desired for CD storage, select the CD-R or CD-RW speed, as well as other steps requiring manual user input prior to conversion of the specified files and recording of the converted files onto the CD medium. Such interaction is burdensome to consumers that are accustomed to “dragand-drop” procedures that facilitate data storage in common personal computer storage peripherals. Further exacerbating the problem is that mastering software vendors typically utilize proprietary internal software architectures than only enable the associated application to record to a CD medium. Writing CD recording code into an application requires a great deal of expertise in CD formatting as well as knowledge of various CD recorders themselves. This has created a barrier to the introduction of new applications operable to write to CD media because the majority of software developers lack the knowledge, time and other resources required to implement CD recording technologies into software applications.

### SUMMARY OF THE INVENTION

In accordance with an embodiment of the present invention, a computer-readable medium having stored thereon a set of instructions to be executed, the set of instructions, when executed by a processor, cause the processor to perform a computer method of receiving, by an interface, a computer formatted file from an external computer application, converting, by a conversion module, the computer formatted file into a compact disc-compliant format, and outputting, by an output interface, the compact disc-compliant formatted data is provided.

In accordance with another embodiment of the invention, a method for converting a file into a compact disc-compliant format suitable for recording on a compact disc medium comprising receiving, by an interface to a compact disc recorder engine, a file in a first format that comprises data to be recorded on a compact disc from an external computer application, processing, by a module of the compact disc recorder engine, the file in the first format, and outputting, by the compact disc recorder engine, the data in a compact disc-compliant format is provided.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates an exemplary arrangement for providing an interface to a compact disc-recordable recorder engine that facilitates writing to a compact disc-recordable device according to an embodiment of the present invention;

FIG. 2A is an exemplary interface to a compact disc recorder engine implemented as a script interpreter according to an embodiment of the present invention;

FIG. 2B is an exemplary interface to a compact disc recorder engine implemented as an application programming interface according to an embodiment of the present invention; and

FIG. 3 is compact disc recorder engine including various modules that facilitate recording of files input thereto by a compact disc recorder engine interface according to the an embodiment of the present invention.

### DETAILED DESCRIPTION OF THE DRAWINGS

The preferred embodiment of the present invention and its advantages are best understood by referring to FIGS. 1 through 3 of the drawings, like numerals being used for like and corresponding parts of the various drawings.

The present invention provides a CD-R, or a CD-RW, engine with an open interface that may be published to facilitate development of applications that interface with a CD-R and/or CD-RW device. With reference to FIG. 1, there is illustrated an exemplary arrangement for providing an interface 10 to a CD-R recorder engine 20 that facilitates writing to a CD-R device 30 according to the teachings of the invention. CD recorder engine 20 may alternatively be implemented as a CD rewritable engine for writing to a CD-RW device. In one embodiment, a script interpreter provides an interface to a CD recorder engine 20. CD recorder engine 20 drives CD-R device 30 and provides CD-compliant media, such as media written to a CD according to volume and file structures defined in ISO 9660, formatted data, thereto. CD-compliant media may include CD-compliant data, CD-compliant audio, and CD-compliant video. A developer of the CD recorder engine 20 may facilitate development of third party applications capable of recording to CD-R device 30 by developing interface 10 and publishing the interface, as well as header files, libraries, and other documentation, that simplify inter-application communications between an external application 65 and CD recorder engine 20.

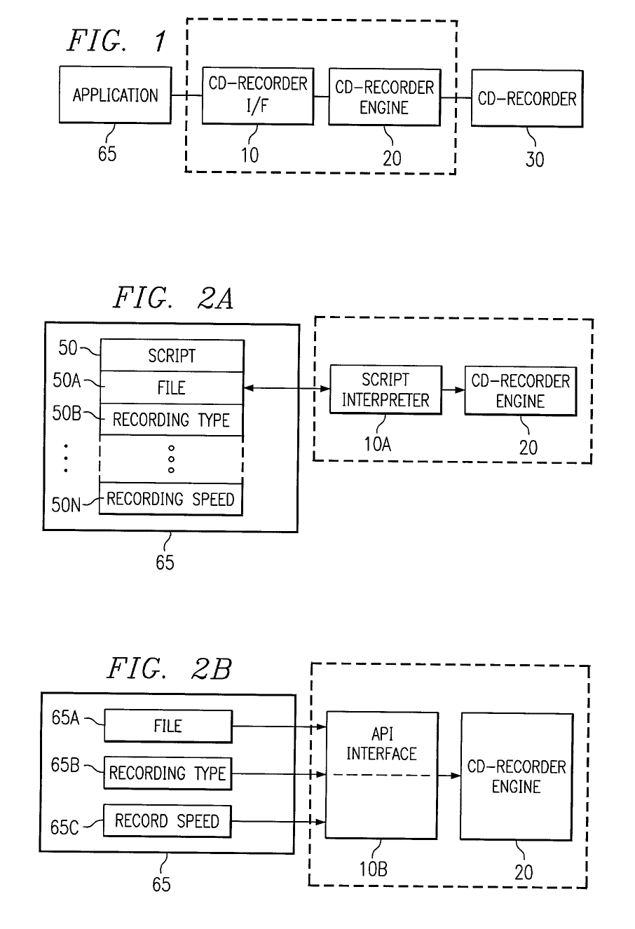

In FIG. 2A, there is illustrated an exemplary interface to CD recorder engine 20 implemented as a script interpreter 10A. Script 50 may be input into script interpreter 10 by an application 65 external to CD recorder engine 20. The script 50 may include information specifying a file 50A, such as an audio file in MPEG-1, audio layer 3 (.mp3) format, that is to be recorded onto a CD medium by CD-R device 30. The script may also specify one or more directives such as a recording type 50B, a recording speed 50N as well as other commands and/or controls. A recording type directive may specify the desired recording mode, for example an audio recording mode, a video recording mode or a data recording mode. The script is then read and interpreted by script interpreter 10. CD recorder engine 20 may retrieve files specified by script 50 and process the files accordingly. Exemplary scripts 50 include batch files, shell scripts and tool command language scripts.

In FIG. 2B, there is illustrated an alternative interface to CD recorder engine 20. An application programming interface (API) 10B may be provided with CD recorder engine 20 that allows interfacing by an external application 65 with CD recorder engine 20. Through API 10B, application 65 may access CD recorder engine 20 services. API 10B is “callable” by external application 65 and provides a high-level language interface to lower-level utility and hardware instructions provided by CD recorder engine 20. Accordingly, application 65 may provide a file 65A, a recording type 65B, a recorder speed 65C, as well as other information for directing CD recorder engine 20 to record file 65A on a CD medium by CD-R device 30. Thus, a developer of application 65 need not be fluent in the intricacies of CD format structures and particular hardware commands associated with a particular CD-R device 30. Rather, a developer of application 65 need only be proficient at API programming procedures.

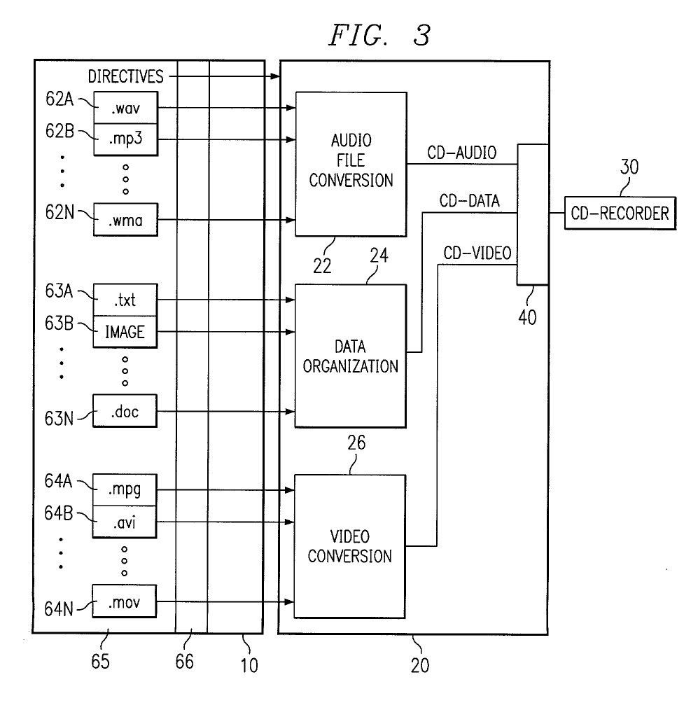

CD recorder engine 20 may include any number of modules that facilitate recording of files input thereto by CD recorder engine interface 10, as illustrated in FIG. 3. For example, CD recorder engine 20 may include an audio file conversion module 22 for converting computer audio formatted files into a CD-audio compliant format. Exemplary computer audio formatted files that may be input by application 65 via CD recorder interface 10 include wave formatted files 62A, MPEG-1, audio layer-3 formatted files 62B and windows media audio (.wma) formatted files 62N. The various computer formatted audio files 62A-62N are input into CD recorder engine 20 and processed by audio file conversion module 22 that outputs CD-audio compliant audio, such as a pulse code modulated format described and known according to ‘red book’ standards, suitable for recording on a CD medium by CD-R device 30.

CD recorder engine 20 may include a data organizational module 24 for organizing computer data files, for example computer text (.txt) files 63A, image files 63B and word processor files such as document files (.doc) 63N, into a CD-data compliant organizational format for recording onto a CD medium by CD-R device 30. Data organizational module 24 may convert a data file input into CD recorder engine 20 via CD engine interface 10 into data organized according to standards specified in the industry that define data structures and storage organizations for storage on CD media.

CD recorder engine 20 may include a video conversion module 26 for converting computer video formatted files, such as digital versatile disc (DVD) files, video CD (VCD) files and super video CD (SVCD) files, into a CD-compliant video format. Exemplary computer video formatted files that may be input into CD recorder engine 20 and processed by video conversion module 26 include MPEG video (.mpg) files 64A, audio video interleave (.avi) files 64B and moving joint photographic experts group (.mov) files 64N.

CD recorder engine 20 preferably includes an output interface 40 for outputting CD-compliant media thereto. Output interface 40 may include program logic for directing media output by one or more of the conversion modules of CD recorder engine 20 to an output port of a computer executing CD recorder engine 20. For example, output interface 40 may direct output from CD recorder engine 20 to an output port, such as a parallel port, a universal serial bus or other peripheral interface that connects the computer executing the CD recorder engine 20 with CD-R device 30. Alternatively, output interface 40 may direct CD recorder engine 20 output to an internal computer interface such as an integrated drive electronics interface, a peripheral component interconnect interface or another internal interface allowing CD recorder engine 20 to provide output therefrom to CD-R device 30.

A developer of CD recorder engine 20 may enhance market acceptance and penetration by offering and publishing CD engine interface 10 for use in conjunction with CD recorder engine 20. The CD recorder engine interface developer may provide additional support code, such as header files, libraries, dynamic link libraries and other application utilities, that facilitates development of applications 65 capable of communicating with CD recorder engine 20 and providing files thereto. Third party application developers may then develop computer applications 65 operable to write to a CD medium by CD-R device 30 by including an input interface 66 within application 65 that is compatible with CD recorder engine interface 10.

As described, CD recorder engine interface 10 may be implemented as a script interpreter 10A. An application 65 may include an input interface 66 developed according to published scripting protocols for communicating with CD recorder engine interface 10. Various files such as computer audio, video and data may then be passed from application 65 to CD recorder engine interface 10 via input interface 66. CD recorder engine interface 10 then passes the file/s to CD recorder engine 20 where the files are processed by one or more processing modules such as audio file conversion module 22, data organizational module 24 and video conversion module 26. In addition to passing a file for recording onto a CD medium, application 65 may provide any number of directives to CD recorder engine 20, such as a recording type 65B and a record speed 65C, for directing operation thereof. Alternatively, CD recorder engine interface 10 may be an API 10B that is callable by application 65 and that facilitates retrieval of files and directives therefrom.

CD recorder engine 20 and CD recorder engine interface 10 may be implemented as computer executable code that is storable on a storage medium, such as a magnetic hard disk or floppy disk, an optical medium or other digital storage device, and executable by a central processing unit of a computer. An external computer application, such as a third party computer program, may be executable by the computer and may communicate with the CD recorder engine via the CD recorder engine interface. The computer may be connected to one or more CD-recorder devices that record media provided by the external application to the CD recorder engine. Control of the recording process is directed by the CD recorder engine and may be performed in conjunction with one or more logic elements, such as firmware systems, located on the CD recorder device.

What is claimed is:

1. A computer-readable medium having stored thereon a set of instructions to be executed, the set of instructions, when executed by a processor, cause the processor to perform a computer method of:
receiving, by an interface, a computer formatted file from an external computer application;
converting, by a conversion module, the computer formatted file into a compact disc-compliant format; and
outputting, by an output interface, the compact disc-compliant formatted data.

2. The computer-readable medium according to claim 1, wherein the interface operable to receive the computer formatted file comprises a script interpreter.

3. The computer-readable medium according to claim 2, wherein the computer formatted file is specified in a script file provided to the script interpreter by the external computer application, the script file comprising a list of one or more file names to be converted by the conversion module and output by the output interface.

4. The computer-readable medium according to claim 2, wherein a script file is provided to the script interpreter by the external computer application, the script file specifying a recording speed.

5. The computer-readable medium according to claim 2, wherein a script file is provided to the script interpreter by the external computer application, the script file specifying a recording type.

6. The computer-readable medium according to claim 1, wherein the interface operable to receive the computer formatted file is an application programming interface callable by the external computer application.

7. The computer-readable medium according to claim 6, wherein the external computer application provides one or more directives executable by the processor, the one or more directives comprising a recording speed.

8. The computer-readable medium according to claim 6, wherein the external computer application provides one or more directives executable by the processor, the one or more directives comprising a recording type.

9. The computer-readable medium according to claim 1, wherein the compact disc-compliant formatted data comprises pulse code modulated data that may be written to a compact disc.

10. A method for converting a file into a compact disc-compliant format suitable for recording on a compact disc medium, comprising:
receiving, by an interface to a compact disc recorder engine, a file in a first format that comprises data to be recorded on a compact disc from an external computer application;
processing, by a module of the compact disc recorder engine, the file in the first format; and
outputting, by the compact disc recorder engine, the data in a compact disc-compliant format.

11. The method according to claim 10, wherein the first format is one of a computer audio format, a computer video format and a computer data format.

12. The method according to claim 10, wherein processing the file further comprises converting, by an audio conversion module of the compact disc recorder engine, the file into a compact disc-compliant audio format.

13. The method according to claim 10, wherein processing the file further comprises converting, by a video conversion module of the compact disc recorder engine, the file in to compact disc-compliant video format.

14. The method according to claim 10, wherein processing the file further comprises organizing, by a organization module of the compact disc recorder engine, the file into a compact disc-compliant data format.

15. The method according to claim 10, wherein receiving the file in the first format further comprises receiving, by the interface to the compact disc recorder engine, the file in the first format specified by a script file provided by the external computer application, the script file interpreted by the interface to the compact disc recorder engine, the compact disc recorder engine retrieving the file in the first format after interpretation of the script file.

16. The method according to claim 15, wherein receiving the file in the first format further comprises receiving the script file that specifies the file in the first format, the script file further specifying one or more directives including one of a recording type and a recording speed.

17. The method according to claim 10, wherein receiving the file in the first format further comprises receiving, by the interface to the compact disc recorder engine, the file in the first format from the external computer application, the interface to the compact disc recorder engine is an application programming interface callable by the external computer application.

18. The method according to claim 17, wherein receiving the file in the first format further comprises calling the application programming interface by the external computer application, a recording speed being provided to the application programming interface by the external computer application.

19. The method according to claim 17, wherein receiving the file in the first format further comprises calling the application programming interface by the external computer application, a recording type being provided to the application programming interface by the external computer application.

20. The method according to claim 10, wherein outputting the data in a compact disc-compliant format further comprises outputting the data to a compact disc recorder device.

21. The method according to claim 10, wherein outputting the data in a compact disc-compliant format further comprises outputting the data to a compact disc rewritable device.
